(19) United States
(12) Patent Application Publication
(10) Pub. No.: US 2022/0003303 A1
(43) Pub. Date: Jan. 6, 2022

(54) BELT PULLEY DECOUPLER HAVING A TOOTHING, AUXILIARY ASSEMBLY DRIVE AND DRIVE MOTOR HAVING A CORRESPONDING BELT PULLEY DECOUPLER, AND A METHOD FOR PRODUCING A CORRESPONDING BELT PULLEY DECOUPLER

(71) Applicant: Schaeffler Technologies AG & Co. KG, Herzogenaurach (DE)

(72) Inventors: Joseph Gissler, Friesenheim (DE); Patrick Antusch, Baden-Baden (DE)

(21) Appl. No.: 17/292,700

(22) PCT Filed: Oct. 15, 2019
(86) PCT No.: PCT/DE2019/100890

§ 371 Date: May 10, 2021

(30) Foreign Application Priority Data
Nov. 15, 2018 (DE) 10 2018 128 641.4

(51) Int. Cl. F16H 55/36; F16D 3/12; F16F 15/123

(52) U.S. Cl. CPC F16H 55/36; F16D 3/12; F16F 15/123; F16D 2250/0023; F16F 2236/08; F16H 2055/366; F16D 2250/0084; F16F 2232/02

(57) ABSTRACT

A belt pulley decoupler (1) for an auxiliary assembly drive (2) includes an input part (3) comprising a hub (4); and an output part (5) comprising a belt pulley (6). The output part (5) and the input part (3) can rotate about a common axis of rotation (7). The belt pulley decoupler further includes a first flange (8) having a first toothing (30), with the first flange (8) being connected to the hub (4) by means of a toothing (9); and a second flange (31) having a second toothing (32), with the second toothing (32) being connected to a third toothing (33) formed by the toothing (9) on the hub (4).

### CROSS-REFERENCE TO RELATED APPLICATIONS

This application is the U.S. National Phase of PCT Appln. No. PCT/DE2019/100890 filed Oct. 15, 2019, which claims priority to DE 10 2018 128 641.4 filed Nov. 15, 2018, the entire disclosures of which are incorporated by reference herein.

The present disclosure relates to a belt pulley decoupler for an auxiliary assembly drive, in particular a drive motor of a motor vehicle. In particular, a traction means of the auxiliary assembly drive can be driven by means of the belt pulley decoupler. The present disclosure further relates to an auxiliary assembly drive and a drive motor having such a belt pulley decoupler. The present disclosure further relates to a method for producing a corresponding belt pulley decoupler.

### BACKGROUND

Such pulley decouplers regularly have a damping device having at least one spring accumulator, which serves to reduce torsional vibrations and is arranged between an input part and an output part of the belt pulley decoupler. The input part regularly comprises a hub which can be connected for conjoint rotation to a shaft of a drive motor so as to introduce torque. The torque can be transmitted to the output part via the hub, a flange, and the damping device. The output part regularly comprises a belt pulley having a traction means running surface, wherein the torque can be transferred to the traction means as a tractive force via the belt pulley. To transmit the torque, the individual components of the belt pulley decoupler are connected to one another with form-fitting and/or force-fitting connections. For example, this can be by screwing, riveting, pinning or pressing. However, these types of connection are not always suitable for the transmission of very high torques or a sufficiently large installation space is not available.

### SUMMARY

An object of the present disclosure is therefore to at least partially resolve the problems described with reference to the prior art and in particular to provide a belt pulley decoupler with which high torques can be transmitted and which requires a small installation space. In addition, an auxiliary assembly drive and a drive motor having a belt pulley decoupler should be provided, wherein high torques should be transmittable by the belt pulley decoupler and wherein the belt pulley decoupler requires a small installation space. Furthermore, a method for producing a belt pulley decoupler should be provided with which belt pulley decouplers can be produced with which high torques can be transmitted and which require a small installation space.

These objects may be achieved with a belt pulley decoupler, auxiliary assembly drive, drive motor and method according to the present disclosure. It should be pointed out that the features listed individually in the present disclosure can be combined with one another in any technologically expedient manner and define further embodiments of the present disclosure.

A belt pulley decoupler for an auxiliary assembly drive having at least the following components contributes hereto:

an input part comprising a hub;

an output part comprising a belt pulley, wherein the output part and the input part can rotate about a common axis of rotation;

a first flange having a first toothing, wherein the first flange is connected to the hub by means of a toothing; and

a second flange having a second toothing, wherein the second toothing is connected to a third toothing formed by the toothing on the hub.

A belt pulley decoupler can be a driving wheel of an auxiliary assembly drive or a driven wheel of an auxiliary assembly drive. Such an auxiliary assembly drive serves in particular to drive at least one auxiliary assembly of a drive motor or motor vehicle. An auxiliary assembly can be an auxiliary machine of the motor vehicle that does not implement or does not directly implement its motion. The auxiliary machine can be, for example, an electric motor, a generator, a pump, or a fan. The belt pulley decoupler can in particular transmit a torque of the drive motor to the at least one auxiliary assembly via at least one traction means. For this purpose, an input part of the belt pulley decoupler can be coupled to the drive motor in such a way that the input part can be driven by the drive motor about an axis of rotation. For this purpose, the input part has a hub which can be connected to a shaft of the drive motor for conjoint rotation. The shaft can be, for example, a crankshaft, balancer shaft, intermediate shaft, or camshaft. The input part is coupled to an output part so that the output part can be rotated about the axis of rotation with the input part.

The output part has a traction means running surface for the at least one traction means. The traction means running surface is in particular formed on a circumferential surface of a belt pulley of the output part so that torque can be transmitted as tractive force to the at least one traction means. The designations input part and output part refer to a torque flow direction in which the belt pulley decoupler is a driving wheel that can be driven by the drive motor, which can be an internal combustion engine or an electric motor, for example. However, the belt pulley decoupler can also be a wheel driven by the traction means, which serves to drive an auxiliary assembly.

The belt pulley decoupler also has a first flange with a first toothing and a second flange with a second toothing. The first flange is connected to the hub by means of a toothing which is, in particular, a caulking toothing. The first flange and/or the second flange is in particular a sheet metal component. Furthermore, the first flange and/or the second flange is in particular configured to be annular. The first flange and/or the second flange can be rotated about the axis of rotation with the input part and/or the output part. In particular, the torque can be transmitted from the hub to the belt pulley via the first flange. For this purpose, the first flange is connected to the hub by means of the toothing or the caulking toothing for conjoint rotation. The first toothing of the first flange is formed in particular on an inner circumferential surface of the first flange. To produce the toothing or caulking toothing, the first flange is pressed onto the hub with its first toothing. The first toothing cuts into the hub so that a torsion-proof connection is created. The first toothing forms a third toothing on the hub during the joining process. The second flange can then be fastened to this third toothing by means of its second toothing. For this purpose, the second toothing can engage with the third toothing in a form-fitting manner so that the second flange is connected to the hub for conjoint rotation. The first toothing, second toothing and/or third toothing can have at least one tooth, preferably a plurality of teeth. The individual teeth of the first toothing, second toothing and/or third toothing run in particular parallel to the axis of rotation. Plastic deformation of the hub is used to produce the toothing or caulking toothing. This can result in chips. These displaced chips can be placed, shot and/or closed in a (closed) chip chamber. The hub can have an extension in the axial direction on which the first flange can be placed before the production of the toothing or caulking toothing. In this way, the first flange can be centered in particular with respect to the hub. Due to the toothing or caulking teeth, no additional components or higher material cost is required for connecting the first flange and the second flange to the hub. Furthermore, very high torques can be transmitted via the toothing or caulking toothing or the third toothing formed on the hub. In addition, the toothing or caulking toothing does not require any additional installation space.

The belt pulley decoupler can have a spring device, by means of which the output part and the input part can rotate to a limited extent relative to one another about the common axis of rotation. The spring device having at least one energy store can be effective between the input part and the output part, so that the output part and the input part can rotate to a limited extent relative to one another. The spring device can be supported on the input part and the output part. The at least one energy store is in particular at least one compression spring, at least one spiral spring, at least one elastic element and/or at least one arc spring. The at least one energy store is arranged in particular on the flange, in particular on an outer circumference of the flange, wherein the flange can rotate about the axis of rotation. The at least one energy store is supported on the one hand on the flange and on the other hand on the belt pulley, so that the torque can be transmitted to the belt pulley of the belt pulley decoupler via the hub, the spring flange and the at least one energy store. The spring device can rotate the input part and the output part relative to one another against a spring force of the spring device. Rotational vibrations or torsional vibrations can in particular be damped and/or eliminated by the spring device.

The first flange can connect the hub to the belt pulley.

The second flange can connect the hub to a rotational vibration damper.

The rotational vibration damper is used in particular for further damping or absorption of the rotational vibrations or torsional vibrations. For this purpose, the rotational vibration damper can be designed in the manner of a centrifugal pendulum device. The second flange can be designed as a centrifugal pendulum flange of the centrifugal pendulum device. The centrifugal pendulum flange can have at least one pendulum mass which is arranged to be displaceable relative to the centrifugal pendulum flange under the action of centrifugal force. Furthermore, the centrifugal pendulum flange can have at least two pendulum masses. For example, the centrifugal pendulum flange can have two, three, or four pendulum masses. The at least one pendulum mass can be displaceable along a predetermined path. In addition, the at least one pendulum mass can be displaceable between a first end position and a second end position. The centrifugal pendulum device can be used for speed-adaptive damping and/or for eliminating the rotational vibrations or torsional vibrations.

The centrifugal pendulum device can be arranged on the input part or the output part. In this way, adapted in each case to the application, an improvement of the damping and/or elimination of the rotational vibrations or torsional vibrations is possible. Furthermore, installation space optimization adapted to the application is possible.

The toothing can be formed on an inner circumference of the first flange. In particular, the toothing can be a caulking toothing.

The toothing or caulking toothing can have a first diameter that is smaller than a second diameter of a collar of the hub. The first diameter is in particular an inner diameter of the first flange. The collar of the hub is, in particular, the region of the hub onto which the first flange is pressed during production of the toothing or caulking toothing. The second diameter is in particular an outer diameter of the collar. Since the first diameter is smaller than the second diameter, a plastic deformation of the hub, by means of which the third toothing is formed on the hub, occurs during the manufacture of the toothing or the caulking toothing.

The toothing can be cut into the hub. This means in particular that the hub is plastically deformed during the manufacture of the toothing or caulking toothing.

The belt pulley decoupler can have a chip chamber for chips produced during production of the toothing or caulking toothing. The chip chamber is in particular a space into which the chips produced during the production or cutting of the toothing or caulking toothing and/or surplus material can enter. The chip chamber can be opened in an axial direction, in particular before the flange is fastened to the hub. After production of the toothing or caulking toothing or the fastening of the first flange to the hub, the first flange can in particular close the chip chamber. As a result, the chips collected in the chip chamber can no longer escape from the chip chamber.

The chip chamber can be designed to be annular.

The first flange can have a greater hardness than the hub. This can ensure that during production of the toothing or caulking toothing (essentially) only the hub is (plastically) deformed. Furthermore, the first flange can have a greater hardness than the second flange. The hardness of the second flange can (essentially) correspond to the hardness of the hub.

According to a further aspect of the present disclosure, an auxiliary assembly drive having at least one traction means is also proposed, wherein the traction means at least partially wraps around at least one belt pulley decoupler according to the present disclosure.

According to yet another aspect of the present disclosure, a drive motor for a motor vehicle is also proposed, wherein a shaft of the drive motor is coupled to a belt pulley decoupler according to the present disclosure.

With regard to further details of the auxiliary assembly drive and/or the drive motor, reference is made to the description of the belt pulley decoupler according to the present disclosure.

According to yet another aspect of the present disclosure, a method for producing a belt pulley decoupler for an auxiliary assembly drive is also proposed, which has at least the following steps:
a) providing a hub, a first flange with a first toothing, and a second flange with a second toothing;
b) pressing the first flange onto the hub so that a third toothing is formed by the first toothing on the hub; and
c) fastening the second flange to the third toothing of the hub.

The method is used in particular to produce a belt pulley decoupler according to the present disclosure for an auxiliary assembly drive. For this purpose, the hub, the first flange and the second flange are initially provided in step a). The first flange is then pressed onto the hub in step b). A toothing or caulking toothing is formed between the first flange and the hub, and a third toothing is cut into the hub by the first toothing. In step c), the second flange is fastened to the third toothing of the hub by means of its second toothing. For further details of the method, reference is made to the description of the belt pulley decoupler according to the present disclosure.

### BRIEF SUMMARY OF THE DRAWINGS

Both the present disclosure and the technical field are explained in more detail below with reference to the figures. It should be noted that the figures show a particularly preferred variant of the present disclosure, but is not limited thereto. Like components are provided with the same reference numerals in the figures. wherein, in an exemplary and schematic manner:

FIG. 1: shows a drive motor having a belt pulley decoupler in a side view;

FIG. 2: shows a belt pulley decoupler in longitudinal section;

FIG. 3: shows a first flange of the belt pulley decoupler in a front view;

FIG. 4: shows the first flange after caulking with a hub of the belt pulley decoupler; and

FIG. 5: shows a detailed view of the flange after caulking with the hub of the pulley decoupler.

### DETAILED DESCRIPTION

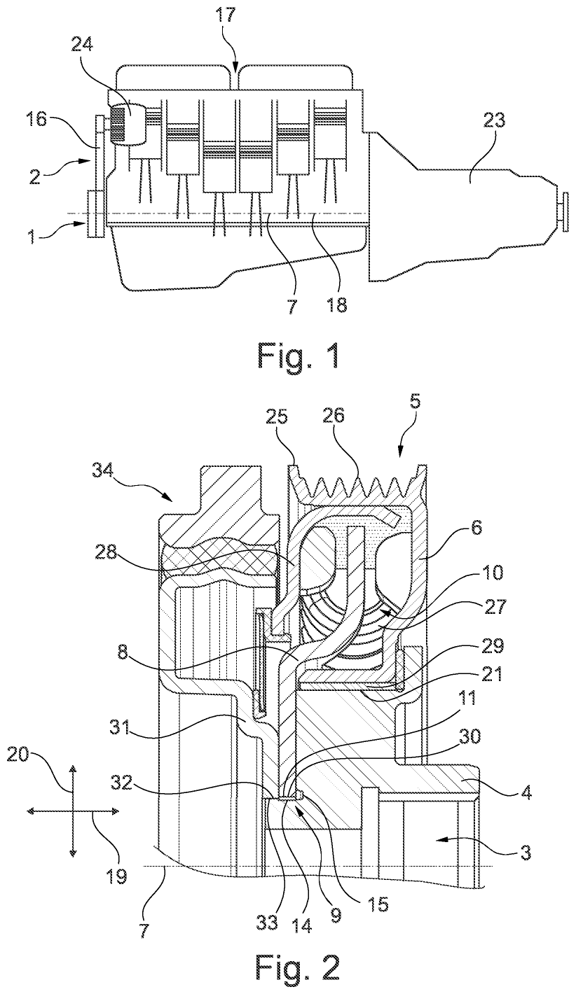

FIG. 1 shows a drive motor 17 having an auxiliary assembly drive 2 in a side view. The auxiliary assembly drive 2 comprises a belt pulley decoupler 1, which is connected to a shaft 18 of the drive motor 17. Here, the shaft 18 is a crankshaft of the drive motor 17. The belt pulley decoupler 1 can be rotated about an axis of rotation 7 by means of the shaft 18. On a side of the drive motor 17 opposite the belt pulley decoupler 1, the shaft 18 is coupled to a transmission 23. An auxiliary assembly 24 can be driven by the belt pulley decoupler 1 via a traction means 16. The auxiliary assembly 24 is a (current) generator, for example in the style of an alternator.

FIG. 2 shows the belt pulley decoupler 1 in a longitudinal section. The belt pulley decoupler 1 has an input part 3 having a hub 4 and a first flange 8. The first flange 8 is annular and has a first toothing 30 radially on the inside. Furthermore, the first flange 8 is pressed onto an outer collar 14 of the hub 4, so that a toothing 9 or caulking toothing is formed between the hub 4 and the first flange 8. The toothing 9 or caulking toothing is formed on an inner circumference 11 of the first flange 8. The belt pulley decoupler 1 also comprises a second flange 31 of a rotational vibration damper 34. The second flange 31 has a second toothing 32 radially on the inside. When the first flange 8 is pressed onto the collar 14, the first toothing 30 of the first flange 8 has a third toothing 33 cut radially outward into the collar 14 of the hub 4. As a result, the second flange 31 can then be fastened to the third toothing 33 of the hub 4 by means of its second toothing 32. The second toothing 32 of the second flange 31 engages positively in the third toothing 33 of the hub 4, so that the second flange 31 is connected to the hub 4 for conjoint rotation. The hub 4 and the first flange 8 are likewise designed to be connected in a torsion-proof manner to one another, wherein the hub 4 can be connected to the shaft 18 of the drive motor 17 shown in FIG. 1, by means of which the hub 4, the first flange 8, and the second flange 31 can be rotated about the common axis of rotation 7. The belt pulley decoupler 1 also has an output part 5 having a belt pulley 6. A traction means running surface 26 for the traction means 16 of the auxiliary assembly drive 2 shown in FIG. 1 is formed on an outer surface 25 of the belt pulley 6. Between the input part 2 and the output part 4, a spring device 10 is provided with a plurality of energy stores 27 distributed in a circumferential direction, wherein the energy stores 27 here are designed in the form of arc springs. The energy stores 27 are supported on the one hand on the flange 8 and on the other hand on the belt pulley 6 or a cover 28 of the belt pulley 6, so that the input part 3 and the output part 5 can rotate to a limited extent relative to one another against a spring force of the energy stores 27. The cover 28 is pressed into the belt pulley 6 in a torsion-proof manner relative to the belt pulley 6. The belt pulley 6 can be rotated to a limited extent about the axis of rotation 7 relative to the hub 4. For this purpose, a sliding bearing 29 is arranged on a circumferential surface 21 of the hub 4. The sliding bearing 29 supports the belt pulley 6 in an axial direction 19 (parallel to the axis of rotation 7) and in a radial direction 20 (orthogonal to the axial direction 19) with respect to the hub 4.

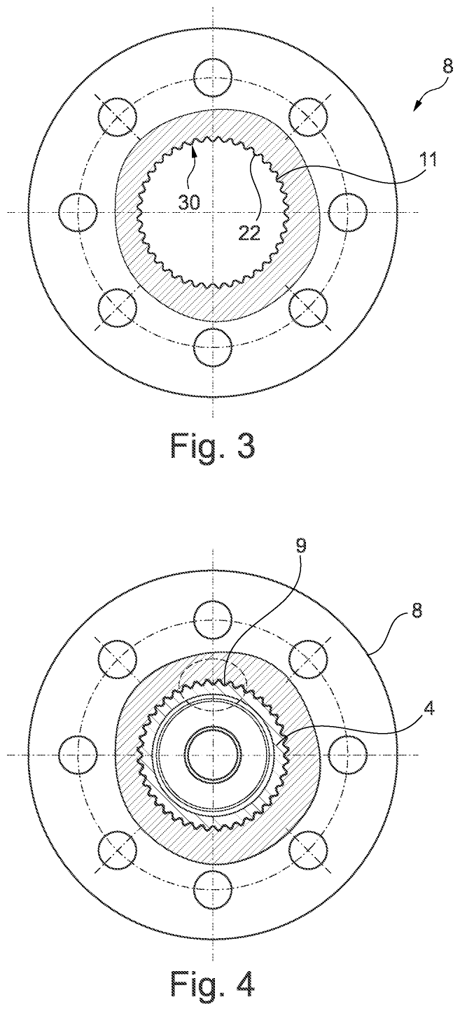

FIG. 3 shows the first flange 8 in a partial section and in a front view. In particular, teeth 22 of the first toothing 30 of the first flange 8 can be seen here on the inner circumference 11 of the first flange 8 before caulking with the hub 4 shown in FIG. 2. The teeth of the second toothing 32, shown in FIG. 2, of the second flange 31 can be designed identically to the teeth 22 of the first toothing 30.

FIG. 4 shows the first flange 8 after caulking with the hub 4 (and before fastening of the second flange 31 shown in FIG. 2). The toothing 9 or caulking toothing was cut into the hub 4 by the toothing 30 shown in FIG. 3 during the caulking or pressing of the flange 8 with the hub 4. The chips produced in the process can be received by an annular chip chamber 15 shown in FIG. 2.

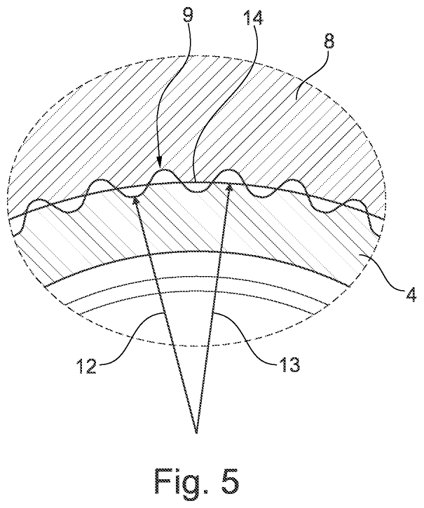

FIG. 5 shows a detailed view of the region of the first flange 8 marked in FIG. 4 after caulking or pressing with the hub 4. The toothing 9 or caulking toothing has a first diameter 12 that is smaller than a second diameter 13 of the collar 14 of the hub 4.

As a result of the present disclosure, a belt pulley decoupler 1 can be operated in a particularly reliable manner and can be produced more cost-effectively.

### LIST OF REFERENCE SYMBOLS

1 Belt pulley decoupler
2 Auxiliary assembly drive
3 Input part
4 Hub
5 Output part
6 Belt pulley
7 Axis of rotation
8 First flange
9 Toothing
10 Spring device
11 Inner circumference
12 First diameter
13 Second diameter
14 Collar
15 Chip chamber
16 Traction means
17 Drive motor
18 Shaft
19 Axial direction
20 Radial direction
21 Circumferential surface
22 Teeth
23 Transmission
24 Auxiliary assembly
25 Outer surface
26 Traction means running surface
27 Energy store
28 Cover
29 Sliding bearing
30 First toothing
31 Second flange
32 Second toothing
33 Third toothing
34 Rotational vibration damper

What is claimed is:

1. A belt pulley decoupler for an auxiliary assembly drive, having at least:
an input part comprising a hub;
an output part comprising a belt pulley, the output part and the input part being rotatable about a common axis of rotation;
a first flange having a first toothing, the first flange being connected to the hub by a toothing; and
a second flange having a second toothing, the second toothing being connected to a third toothing formed by the toothing on the hub.

2. The belt pulley decoupler according to claim 1, further comprising a spring device by which the output part and the input part are rotatable to a limited extent relative to one another about the common axis of rotation.

3. The belt pulley decoupler according to claim 1, wherein the first flange connects the hub to the belt pulley.

4. The belt pulley decoupler according to claim 1, wherein the second flange connects the hub to a rotational vibration damper.

5. The belt pulley decoupler according to claim 1, wherein the toothing is formed on an inner circumference of the first flange.

6. The belt pulley decoupler according to claim 1, wherein the toothing has a first diameter which is smaller than a second diameter of a collar of the hub.

7. The belt pulley decoupler according to claim 1, wherein the first flange has a greater hardness than the hub.

8. An auxiliary assembly drive comprising:
the belt pulley decoupler according to claim 1; and
a traction means at least partially wrapping around the belt pulley decoupler.

9. An assembly comprising:
the belt pulley decoupler according to claim 1; and
a drive motor for a motor vehicle including a shaft coupled to the belt pulley decoupler.

10. A method for producing a belt pulley decoupler for an auxiliary assembly drive comprising:
providing a hub, a first flange with a first toothing, and a second flange with a second toothing;
pressing the first flange onto the hub so that a third toothing is formed on the hub by the first toothing; and
fastening the second flange to the third toothing of the hub.

11. The method as recited in claim 10 wherein the fastening of the second flange to the third toothing of the hub includes pressing the second flange onto the hub so the second toothing engages the third toothing.

12. The method as recited in claim 10 wherein pressing the first flange onto the hub so that the third toothing is formed on the hub by the first toothing includes cutting the third toothing radially into a collar of the hub.

13. A belt pulley decoupler for an auxiliary assembly drive comprising:
an input part comprising a hub;
an output part comprising a belt pulley, the output part and the input part being rotatable about a common axis of rotation;
a first flange having a first toothing, the first flange being connected to the hub by the first toothing engaging a third toothing on the hub, the first flange having a greater hardness than the hub; and
a second flange having a second toothing, the second toothing being connected to the third toothing in a form-fitting manner.

14. The belt pulley decoupler as recited in claim 13 further comprising energy stores, the energy stores being supported by the first flange and the belt pulley or a cover of the belt pulley so that the input part and the output part are rotatable to a limited extent relative to one another against a spring force of the energy stores.

15. The belt pulley decoupler as recited in claim 14 further comprising a sliding bearing radially between the hub and the belt pulley rotatably supporting the belt pulley on the hub.

16. The belt pulley decoupler as recited in claim 13 further comprising a cover non-rotatably held in the belt pulley.

17. The belt pulley decoupler as recited in claim 13 wherein teeth of the first toothing are identical to teeth of the second toothing.

18. The belt pulley decoupler as recited in claim 13 wherein the hub includes an annular chip chamber receiving chips formed during a pressing of the first flange onto the hub.

19. The belt pulley decoupler as recited in claim 13 wherein the first flange has a greater hardness than the second flange.
